(19) United States
(12) Patent Application Publication
(10) Pub. No.: US 2009/0009151 A1
(43) Pub. Date: Jan. 8, 2009

(54) REFERENCE VOLTAGE GENERATOR WITH BOOTSTRAPPING EFFECT

(75) Inventor: Matthias Arnold, Freising (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND GMBH, Freising (DE)

(21) Appl. No.: 12/166,031

(22) Filed: Jul. 1, 2008

Related U.S. Application Data
(60) Provisional application No. 61/016,721, filed on Dec. 26, 2007.

(30) Foreign Application Priority Data
Jul. 4, 2007 (DE) 102007031054.6

(51) Int. Cl. G05F 3/16

(52) U.S. Cl. 323/313

(57) ABSTRACT

An integrated electronic device for generating a reference voltage. The circuitry has a bias current generator for generating a first bias current, a diode element coupled to the bias current generator and fed by a second bias current derived from the first bias current for converting the second bias current into a reference voltage across the diode element, a supply voltage pre-regulator stage for regulating the supply voltage used for the bias current generator, and an output buffer coupled to the reference voltage for providing a low impedance output, wherein the reference voltage is coupled to the supply pre-regulator stage for biasing the supply pre-regulator stage by the reference voltage.

### FIELD OF THE INVENTION

The present invention relates to an integrated electronic device including circuitry for generating a reference voltage, more specifically to a reference voltage generator.

### BACKGROUND OF THE INVENTION

Integrated electronic devices need reference voltage generators for all kinds of biasing tasks, data retention and predefined operating currents. A general requirement is a very low power consumption of the reference voltage generators. Further, any reference voltage should be stable over a wide input supply range and variations of the operating conditions, such as temperature or the like. In order to get a very stable reference output voltage, reference voltage generators can include cascode stages to make the output voltage independent from supply voltage variations. Another conventional approach to increase the power supply rejection ratio (PSRR) of reference voltage generators involves a pre-regulation of the supply voltage level used for the reference voltage generator. However, using a pre-regulation stage or cascode configurations increases chip area and power consumption, since additional circuitry is needed for the pre-regulation stage.

### SUMMARY OF THE INVENTION

It is a general object of the present invention to provide a reference voltage generator with a high PSRR having lower power consumption and a reduced chip area as compared to prior art voltage generators.

According to an aspect of the present invention, an integrated electronic device is provided, which includes circuitry for generating a reference voltage. The circuitry includes a bias current generator for generating a first bias current, a diode element coupled to the bias current generator and fed by a second bias current derived from the first bias current for converting the second bias current into a reference voltage across the diode element, a supply voltage pre-regulator stage for regulating the supply voltage used for the bias current generator and an output buffer coupled to the reference voltage for providing a low impedance output. The reference voltage is coupled to the supply pre-regulator stage for biasing the supply pre-regulator stage by the reference voltage. Accordingly, a voltage reference generator is provided, which makes use of a bootstrapping effect by using the stabilized output voltage of the bias current generator as a reference voltage for the pre-regulator stage. The supply voltage of the bias current generator is stabilized by the pre-regulator stage, which is turn is stabilized by the constant reference output voltage of the bias current generator. Reusing the output voltage of the bias current generator for the supply pre-regulator reduces the number of branches necessary to provide all the bias voltages and currents for the different stages of the reference voltage generator.

According to another aspect of the present invention, the supply voltage pre-regulator stage is fed by a third bias current derived from the first bias current. Accordingly, not only the reference voltage produced by the bias current generator is reused, but also the bias current of the stage is used for the pre-regulation of the supply voltage of the bias current generator. This can be done by mirroring the bias current from the bias current generator into the pre-regulator stage. Preferably, the bias current determined by the bias current generator stage is used multiple times for the pre-regulator stage. Using integer multiples of the first bias current for the pre-regulator stage allows for a simple and robust implementation. The diode element can be implemented as a serial or a parallel combination of at least one of an NMOS transistor, a PMOS transistor, a bipolar transistor, a diode and/or a resistor.

According to another aspect of the present invention, a method for generating a reference voltage is provided, which includes providing a first bias current by a bias current source, providing the reference voltage by use of the first bias current and using the reference voltage for pre-regulating the supply voltage of the bias current source. Further, the first bias current can be used for pre-regulating the supply voltage of the bias current source. According to this bootstrapping approach, it is possible to save power and chip area. The circuitry being interconnected in accordance with the present invention may have more than one stable operating points. Accordingly, the electronic device according to the present invention needs a startup circuit, which is preferably coupled to the bias current generator stage. The startup stage provides that the whole circuitry for generating a reference voltage enters into a stable operating point, in which the required reference voltage is generated.

### BRIEF DESCRIPTION OF THE DRAWINGS

Further aspects of the present invention will ensue from the description hereinbelow of A preferred embodiment with reference to the accompanying drawings, wherein

shows a simplified circuit diagram of a preferred embodiment of the present invention, and

shows a simplified circuit diagram of examples for a diode element according to the present invention.

### DETAILED DESCRIPTION

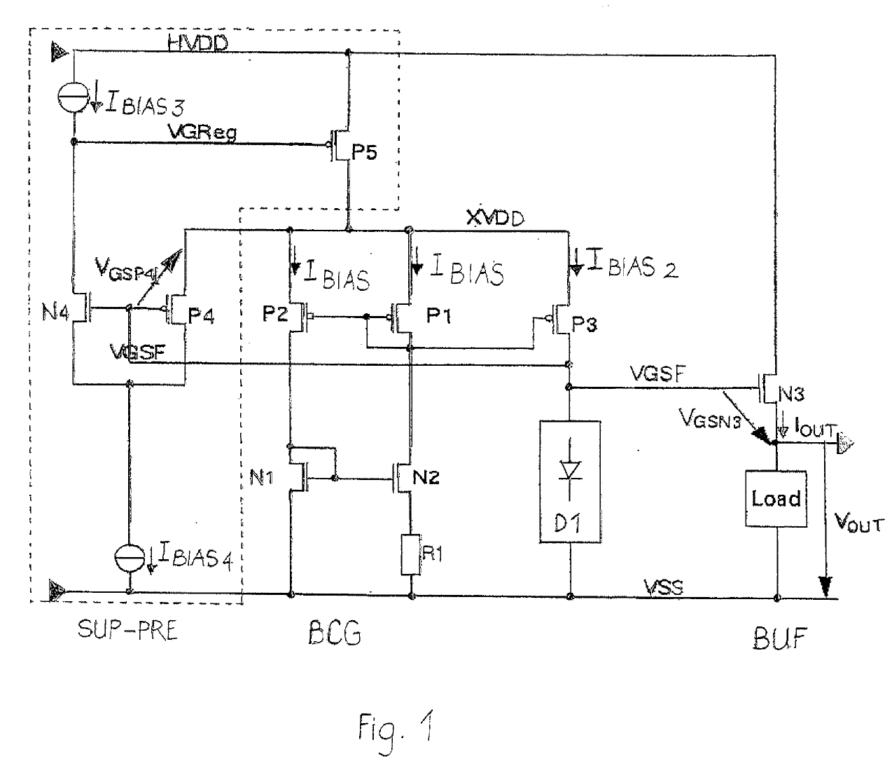

FIG. 1 shows a simplified circuit diagram of a preferred embodiment of the present invention. Accordingly, a bias generator stage BCG including transistors P1, P2, P3, N1, N2 and a resistor R1 is provided. The bias generator BCG outputs a second reference current I_{BIAS2}, derived from a first current I_{BIAS}, being coupled to a diode element D1. The diode element D1 is an example of a diode stack, i.e. multiple diode like elements coupled in series or in parallel in order to provide a stabilized output reference voltage VGSF from a constant current. Accordingly, the bias current I_{BIAS2} causes a voltage drop VGSF over the diode stack D1, which can combine various threshold voltages V_{THP} and V_{THN}, saturation voltages V_{DSAT}, base-emitter voltages V_{BE} or other voltages V_{R}, mainly depending on the desired voltage characteristic and the technology used for manufacturing the integrated circuit.

The bias generator stage BCG is supplied by a supply voltage XVDD. This supply voltage XVDD is provided by a supply pre-regulator SUP-PRE. The supply pre-regulator SUP-PRE includes transistors P5, N4, P4 and two bias current sources I_{BIAS3} and I_{BIAS4}. The reference output voltage VGSF of the bias current generator BCG is coupled to the gates of transistors N4 and P4. The PMOS transistor P5 is coupled between the primary supply voltage HVDD and the supply voltage XVDD of the bias generator stage BCG. The bias current sources I_{BIAS3} and I_{BIAS4} are preferably derived from the bias current I_{BIAS} indicated within the two branches of the bias current generator stage BCG. For example, this can be done by current mirrors (not shown) coupled to BCG. The output buffer BUF is implemented by an NMOS transistor N3. The gate voltage of N3 is defined by the reference voltage VGSF and the gate source voltage of N3 is V_{GSN3}. The bias current generator BCG provides also the bias currents I_{BIAS3} and I_{BIAS4} for the supply pre-regulator SUP-PRE (I_{BIAS3}, I_{BIAS4}). The pre-regulator SUP-PRE controls the voltage XVDD such that it is equal to VGSF plus the gate source voltage V_{GSP4} of P4 by the loop consisting of N4, P4 and P5. The output buffer BUF provides a low impedance output and operates as a source follower such that the output voltage V_{OUT} is equal to VGSF minus the gate to source voltage of N3, V_{GSN3}. Preferably, I_{BIAS3} is equal to n times I_{BIAS}, and I_{BIAS4} is equal to m times I_{BIAS}. n and m are preferably integer values. By the bootstrapping connection, according to which the current generator provides bias currents I_{BIAS3} and I_{BIAS4} to the pre-regulator SUP-PRE, and the diode stack D1 itself being supplied from the supply pre-regulator SUP-PRE, the number of branches having a constant current between the positive and negative supply voltage is reduced. Accordingly, the overall power consumption of the circuit shown is less than without the bootstrap mechanism according to the invention. Generally, the circuit shown in FIG. 1 is a self-referenced circuit, which minimizes the branches where a current flows such that a very low power consumption can be achieved. The source follower N3, with its gate connected to the diode stack, makes the reference output low impedance, such that it can supply high load currents. In particular, the circuit is a combination of several circuit concepts, such as a bias circuit BCG, a voltage reference, and a pre-regulator SUP-PRE in a single compact circuit, such that the power consumption and the required chip area is substantially reduced. The circuit according to an aspect of the present invention has a very low current consumption, such that the total current consumed by the circuitry might be as low as e.g. 200 nA or lower. Also, the circuit shows only a very limited output voltage variation and a high PSRR. Also, the temperature dependency is substantially reduced.

As the circuitry shown in FIG. 1 can have more than one stable operating point, e.g. one where the reference voltage VGSF is zero, and another having the desired reference voltage VGSF, it can be necessary to use a start-up circuit to force the circuit into the correct operating point. Such startup circuit, which is not shown in FIG. 1, can preferably be coupled between transistors N1 and P2, where the circuit may inject a specific small current when the circuitry is powered up.

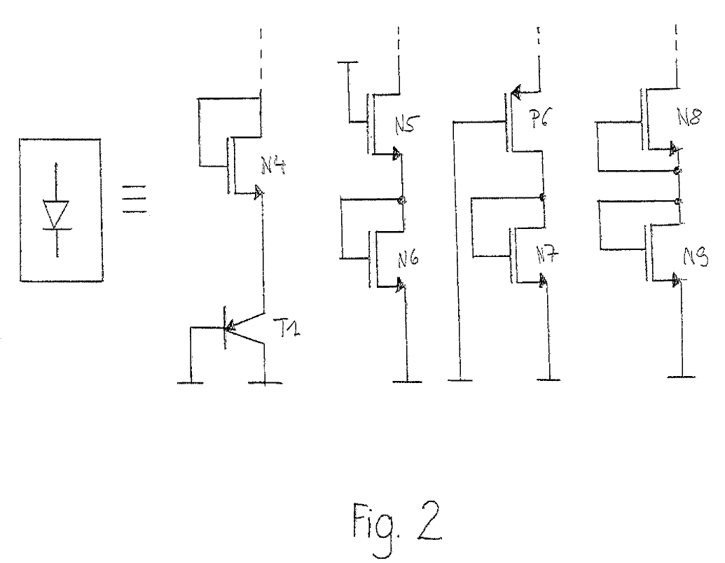

FIG. 2 shows some illustrative examples of implementations of the diode element D1, i.e. the diode stack of FIG. 1. Accordingly, the diode stack D1 can be a combination of an NMOS transistor N4 and a bipolar transistor T1, two NMOS transistors N5 and N6 in series, a PMOS transistor P6 and an NMOS transistor N7 in series or two NMOS transistors N8 and N9 coupled as shown in FIG. 2. There are many more possibilities to combine the devices shown in FIG. 2 in parallel or in series in order to achieve a stable reference output voltage VGSF.

Although the present invention has been described with reference to a specific embodiment, it is not limited to this embodiment and no doubt alternatives will occur to the skilled person that lie within the scope of the invention as claimed.

1. An integrated electronic device comprising circuitry for generating a reference voltage, the circuitry comprising:
a bias current generator for generating a first bias current,
a diode element coupled to the bias current generator and fed by a second bias current derived from the first bias current for converting the second bias current into a reference voltage across the diode element,
a supply voltage pre-regulator stage for regulating the supply voltage used for the bias current generator, and
an output buffer coupled to the reference voltage for providing a low impedance output, wherein
the reference voltage is coupled to the supply pre-regulator stage for biasing the supply pre-regulator stage by the reference voltage.

2. The integrated electronic device according to claim 1, wherein the supply voltage pre-regulator stage is fed by a third bias current derived from the first bias current.

3. The integrated electronic device according to claim 2, wherein the supply voltage pre-regulator stage is fed by a fourth bias current derived from the first bias current.

4. The integrated electronic device according to claim 1, wherein second, third and fourth bias currents are integer multiples of the first bias current.

5. The integrated electronic device according to claim 1, wherein the diode element is a series combination of at least one of an NMOS transistor, a PMOS transistor, a bipolar transistor, a diode and a resistor.

6. A method for generating a reference voltage, comprising: providing a first bias current by a bias current source, providing the reference voltage by use of the first bias current, and using the reference voltage for pre-regulating the supply voltage XV of the bias current source.

7. The method according to claim 6, comprising using the first bias current for pre-regulating the supply voltage of the bias current source.

8. The integrated electronic device according to claim 2 wherein second, third and fourth bias currents are integer multiples of the first bias current.

9. The integrated electronic device according to claim 3 wherein second, third and fourth bias currents are integer multiples of the first bias current.

10. The integrated electronic device according to claim 2, wherein the diode element is a series combination of at least one of an NMOS transistor, a PMOS transistor, a bipolar transistor, a diode and a resistor.

11. The integrated electronic device according to claim 3, wherein the diode element is a series combination of at least one of an NMOS transistor, a PMOS transistor, a bipolar transistor, a diode and a resistor.

12. The integrated electronic device according to claim 4, wherein the diode element is a series combination of at least one of an NMOS transistor, a PMOS transistor, a bipolar transistor, a diode and a resistor.

13. The integrated electronic device according to claim 2, wherein the diode element is a parallel combination of at least one of an NMOS transistor, a PMOS transistor, a bipolar transistor, a diode and a resistor.

14. The integrated electronic device according to claim 3, wherein the diode element is a parallel combination of at least one of an NMOS transistor, a PMOS transistor, a bipolar transistor, a diode and a resistor.

15. The integrated electronic device according to claim 4, wherein the diode element is a parallel combination of at least one of an NMOS transistor, a PMOS transistor, a bipolar transistor, a diode and a resistor.
